(19) United States
(12) Patent Application Publication
(10) Pub. No.: US 2011/0156541 A1
(43) Pub. Date: Jun. 30, 2011

(54) SPINDLE MOTOR

(75) Inventor: Chung Hyun Song, Gwangju (KR)

(73) Assignee: LG Innotek Co., Ltd., Seoul (KR)

(21) Appl. No.: 13/042,125

(22) Filed: Mar. 7, 2011

Related U.S. Application Data
(62) Division of application No. 12/541,693, filed on Aug. 14, 2009.

(30) Foreign Application Priority Data
Aug. 19, 2008 (KR) 10-2008-0080967

(51) Int. Cl. H02K 5/167

(52) U.S. Cl. 310/425

(57) ABSTRACT

A spindle motor is disclosed, wherein the spindle motor is integrally formed by a one side-exposed cylindrical bearing housing by pressing a metal sheet plate to save material costs and to simplify an assembly process of constituent elements, whereby the manufacturing cost can be reduced, and a bearing housing is press-fitted or bonded to a base without caulking process to make a perpendicularity of the bearing housing against the base accurate, whereby a perpendicularity of a rotation shaft against the base is also accurate, and whereby noise and vibration are reduced, and the integral formation of the bearing housing inhibits oil discharged from the bearing from leaking toward a lower surface of the bearing housing, thereby prolonging the life of the product.

### CROSS-REFERENCE TO RELATED APPLICATIONS

This application is a divisional of U.S. application Ser. No. 12/541,693, filed Aug. 14, 2009, claims the benefit under 35 U.S.C. §119 of Korean Patent Application No. 10-2008-0080967, filed Aug. 19, 2008, which is hereby incorporated by reference in its entirety.

### BACKGROUND

The present disclosure relates to a spindle motor. A spindle motor performs the function of rotating a disk to enable an optical pickup which linearly reciprocates in an optical disk drive (ODD) to read data recorded on the disk.

In general, a spindle motor includes a rotation shaft to which a turntable accommodated with a disk is coupled, a bearing housing supporting a bearing, and a base plate on which the bearing housing is vertically fixed. The bearing housing and the bearing are so manufactured as to have a high level of accuracy in order to maintain plumbness of the rotation shaft and to prevent the rotation shaft from trembling. It is one of the more important points for quality control of a spindle motor to constantly maintain assembly accuracy between the bearing housing and the base plate when the bearing housing is coupled to the base plate.

### BRIEF SUMMARY

The present disclosure is to provide a spindle motor capable of greatly simplifying the manufacturing and quality control processes while maintaining assembly accuracy between a bearing housing and a base plate and reducing the manufacturing cost, vibration and noise to thereby enhance durability of the spindle motor.

According to one aspect of the present disclosure, the object described above may be achieved by a spindle motor which comprises: a bearing housing coupled to a base by bending a plate to have a cylindrical shape with one side closed; a bearing fixed inside the bearing housing; a rotation shaft supportively and rotatably installed in the bearing; a rotor coupled to the rotation shaft to simultaneously rotate with the rotation shaft; and a stator having a core and a coil wound on the core and fixed to the bearing housing.

According to another aspect of the present invention, the object described above may be achieved by a spindle motor which comprises: a bearing housing coupled to a base by bending a plate to have a cylindrical shape with one side closed; a support member attached to the base for supportively wrapping the bearing housing; a bearing fixed inside the bearing housing; a rotation shaft supportively and rotatably installed in the bearing; a stator having a core and a coil wound on the core and fixed to the bearing housing; and a rotor having a rotor yoke coupled to the rotation shaft and a magnet coupled to the rotor yoke for rotating in association with the stator.

### BRIEF DESCRIPTION OF DRAWINGS

FIG. 1 is a cross-sectional view of a spindle motor according to an exemplary embodiment of the present invention.

FIG. 2 is a cross-sectional view of a spindle motor according to another exemplary embodiment of the present invention.

### DETAILED DESCRIPTION

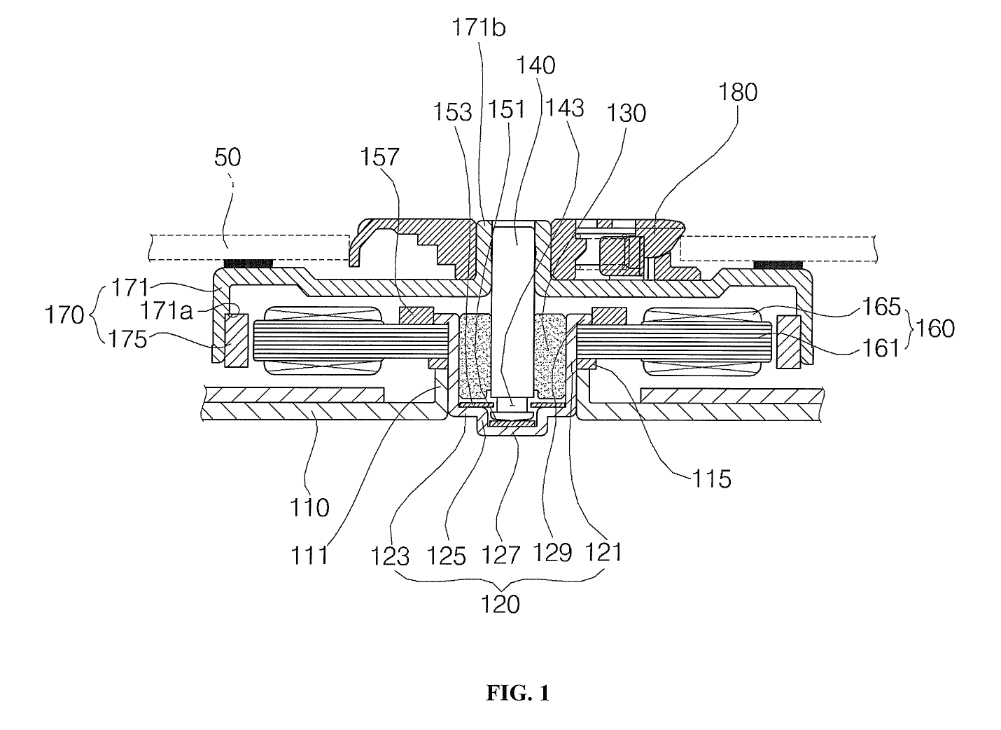

FIG. 1 is a cross-sectional view of a spindle motor according to an exemplary embodiment of the present invention.

Referring to FIG. 1, a plate-shaped base 110 centrally formed with a coupling portion 111 is provided, and a bearing housing 120 is vertically inserted in an inner periphery of the coupling portion 111. The bearing housing 120 is provided in a cylindrical shape with an open side, and an outer periphery at the other side of the bearing housing 120 is insertedly coupled to an inner periphery of the coupling portion 111.

Hereinafter, in the description of directions and surfaces of constituent elements relative to vertical direction of the base 110, a surface and a direction facing a vertical upper side of the base 110 are referred to as ‘upper surface’ and ‘upper side’ and a surface and a direction facing a lower side of the base 110 are referred to as ‘lower surface’ and ‘lower side’.

The bearing housing 120 includes a vertical pipe 121 inserted into an inner periphery of the coupling portion 111 by an outer periphery of a lower end thereof, an extension edge 123 extended from the lower end of the vertical pipe 121 to a central side of the vertical pipe 121, an extension pipe 125 extended from an inner periphery of the extension edge 123 to a lengthwise external side of the vertical pipe 121, and a prop plate 127 that hermetically seals the lower end of the extension pipe 125, where the above-mentioned constituent elements of the bearing housing 120 are integrally formed on a pressed sheet.

Furthermore, an upper surface of the vertical pipe 121 is formed with a hitching edge 129 bent toward a radial external direction of the vertical pipe 121. The inner periphery of the vertical pipe 121 is press-fitted by a bearing 130, where the bearing 130 is rotatably installed by being supported by a lower outer peripheral surface of a rotation shaft 140.

Although it makes no difference to allow the lower end of the rotation shaft 140 to supportively contact an upper surface of the prop plate 127, but if the metallic rotation shaft 140 and the metallic prop plate 127 are directly brought into contact, there is a high likelihood of generating a large noise and friction force when the rotation shaft 140 is rotated, such that an upper surface of the prop plate 127 is installed with a thrust plate 151 for reducing the noise and the friction force. That is, the thrust plate 151 is supportively contacted by the lower end of the rotation shaft 140.

The bearing housing 120 and the rotation shaft 140 are respectively fixed by a stator 160 and a rotor 170.

The stator 160 is installed with a core 161 coupled to the outer periphery of the bearing housing 120 at an upper surface between the hitching edge 129 and the coupling portion 111, and a coil 165 wound on the core 161.

A rotor 170 includes a cylindrical rotor yoke 171 having an opened lower surface opposite to the base 110 and fixed to an outer periphery of the rotation shaft 150 exposed at an upper central side thereof to an upper surface of the bearing housing 120, and a magnet 175 coupled to an inner periphery of the rotor yoke 171 in opposition to the stator 160.

Accordingly, when a current is applied to the coil 165, the rotor 170 is rotated by electromagnetic fields formed between the coil 165 and the magnet 175.

The inner periphery of the rotor yoke 171 is formed with a cross-sectional surface 171a supportively contacted by an outer periphery and an upper surface of the magnet 175, whereby the magnet 175 is more securely coupled to the rotor yoke 171.

Furthermore, the rotor yoke 171 is protrusively and upwardly formed at an upper central surface thereof with a protruding pipe 171b into which the rotation shaft 150 is insertedly coupled. The protruding pipe 171b functions to broaden a coupled area between the rotation shaft 150 and the rotor yoke 171 to enable the rotor yoke 171 to be securely coupled to the rotation shaft 150.

The coupling portion 111 is contacted thereon by a lower surface of a support ring 115, and upper and lower surfaces of the core 161 are contacted by a lower surface of the hitching edge 129 and an upper surface of the support ring 115. That is, the core 161 is securely installed as the core 161 is installed in a way of being inserted between the hitching edge 129 and the support ring 115. Therefore, the core 161 including the stator 160 is not disengaged even if they are dropped.

An outer diameter of the support ring 115 is larger than that of the coupling portion 111, the way of which is to broaden a contact area with the core 161 to thereby further securely support the core 161.

The rotor yoke 171 also serves to function as a turn table on which a disk 50 is mounted. A clamp 180 elastically supporting the disk 50 and inhibiting the mounted disk 50 from disengaging upward of the rotor yoke 171 is installed on the outer perimeter of the rotor yoke 171 coupled to the rotation shaft 150, in order to align the center of the mounted disk 50 with the center of the rotation shaft 150.

The extension edge 123 is installed thereon with a ring-shaped washer stopper 153 to be fixed to a lower surface of the bearing 130. An outer periphery of the rotation shaft 140 opposite to the washer stopper 153 is formed with a ring-shaped hitching groove 143 caved in toward a center of the rotation shaft 140. The hitching groove 143 is inserted by an inner periphery of the washer stopper 153, whereby the rotation shaft 140 is prevented from being disengaged toward an upper side of the bearing housing 120.

The core 161 is fixed thereon with a suction magnet 157 to face an upper surface of the rotor yoke 171. The suction magnet 157 sucks the rotor yoke 171 to prevent the rotor 170 and the rotation shaft 140 from floating upwards.

The spindle motor according to the present invention is configured in such a manner that a sheet metal is pressed to form the bearing housing 120, and the coupling portion 111 is press-fitted by the bearing housing 120 or coupled using adhesive

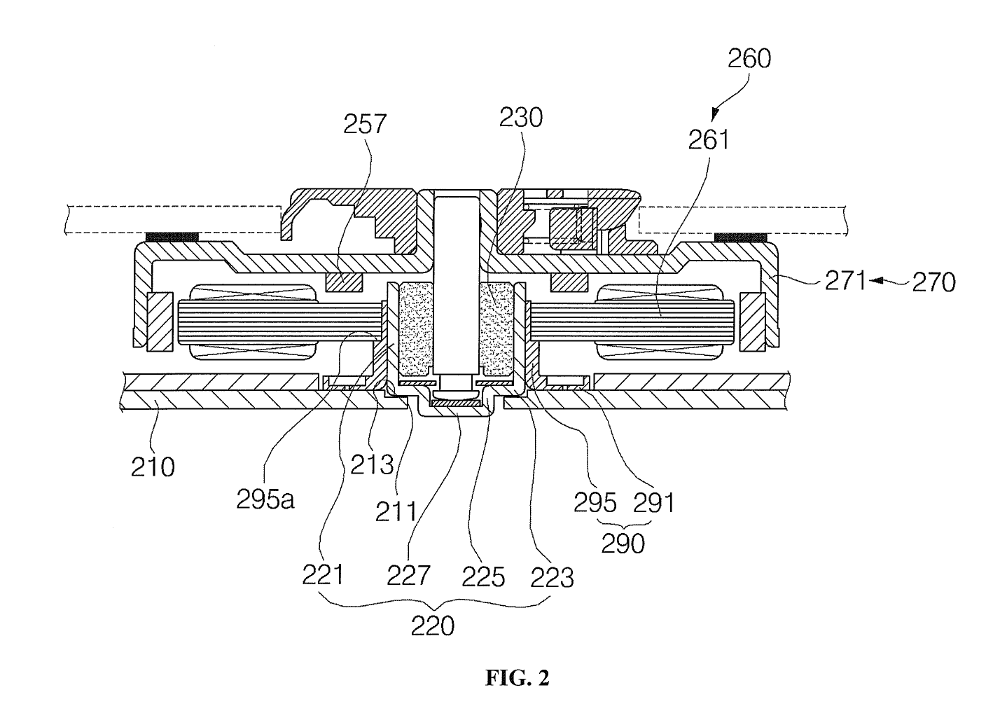

FIG. 2 is a cross-sectional view of a spindle motor according to another exemplary embodiment of the present invention, where only difference from FIG. 1 will be described.

Referring to FIG. 2, a base 210 is formed with a through hole 211 into which an sealed lower side of a bearing housing 220 is inserted. The base 210 is installed with a support member 290 to support in such a manner that the bearing housing 220 can be securely installed at the base 210.

To be more specific, the bearing housing 220 includes a vertical pipe 221 insertedly coupled at an inner periphery by a bearing 230, an extension edge 223 extensively formed from a lower end of the vertical pipe 221 toward a central side of the vertical pipe 221 and supportively contacting an upper surface of the base forming the through hole 211, an extension pipe 225 extended from an inner periphery of the extension edge 223 to an external lengthwise direction of the vertical pipe 221, and a prop plate 227 hermetically sealing a lower end of the extension pipe 225.

The upper surface of the base 210 contacted by the extension edge 223 is caved into a lower surface 213, which is to miniaturize the spindle motor as high as the caved-in unit 213.

Furthermore, a support member 290 includes a ring-shaped coupling plate 291 coupled to the base 210, and a support pipe 295 extensively formed from an inner periphery of the coupling plate 291 to a vertical direction of the coupling plate 291 to supportively contact an outer periphery of the bearing housing 220. That is, the bearing housing 220 is supported by the support member 290 coupled to the base 210 to enable a vertically stable installation of the bearing housing 220 against the base 210.

Furthermore, an outer periphery of the support pipe 295 is formed with a cross-sectional surface 295a supportively contacted by an inner periphery and a lower end of a core 261, whereby the core 261 is more securely coupled to the support member 290.

A suction magnet 257 that prevents a rotor 270 from floating is coupled to an upper surface of a rotor yoke 271 to face the core 261 of a stator 260. That is, the suction magnet 257 tends to be sucked to the core 261.

As apparent from foregoing, the spindle motor according to the present invention is integrally formed by a one side-exposed cylindrical bearing housing by pressing a metal sheet plate to save material costs and to simplify an assembly process of constituent elements. Therefore, the manufacturing cost can be reduced.

Furthermore, a bearing housing is press-fitted or bonded to a base without a caulking process to make a perpendicularity of the bearing housing against the base accurate. Therefore, a perpendicularity of a rotation shaft against the base is also accurate, whereby noise and vibration are reduced.

Still furthermore, the integral formation of the bearing housing inhibits oil discharged from the bearing from leaking toward a lower surface of the bearing housing, thereby prolonging the life of the product.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A spindle motor, comprising: a base formed with a through hole; a bearing housing arranged on the through hole, and having a cylindrical shape with one side closed; a support member attached to the base for supporting the bearing housing; a bearing fixed inside the bearing housing; a rotation shaft rotatably installed by being supported at the bearing; a stator having a core and a coil wound on the core, and arranged about the bearing housing; and a rotor having a rotor yoke coupled to the rotation shaft and a magnet coupled to the rotor yoke to face the coil, and rotating in association with the stator.

2. The spindle motor of claim 1, wherein the support member comprises: a ring-shaped coupling plate coupled to the base; and a support pipe bent from the coupling plate for supporting an outer periphery of the bearing housing.

3. The spindle motor of claim 2, wherein the core is fixed to an outer periphery of the support pipe.

4. The spindle motor of claim 3, wherein the outer periphery of the support pipe is formed with a distal end supportively contacted by the core.

5. The spindle motor of claim 1, wherein a periphery of the through hole of the base is caved in with a sill, the caved-in of which is supportively contacted by the distal end of the bearing housing.

6. The spindle motor of claim 1, wherein the bearing housing comprises: a vertical pipe supported by the support member; an extension edge extended from a distal end of the vertical pipe to a central side of the vertical pipe; an extension pipe extended from a distal end of the extension edge toward the rotation shaft; and a prop plate hermetically sealing the extension pipe.

7. The spindle motor of claim 6, wherein the prop plate is installed with a thrust plate contacted by the rotation shaft, the extension edge is installed with a ring-shaped washer stopper, and an outer periphery of the rotation shaft is formed with a hitching groove where an inner periphery of the washer stopper is inserted and hitched.

8. The spindle motor of claim 1, wherein a central side of the rotor yoke is formed with a protruding pipe insertedly coupled to the rotation shaft.

9. The spindle motor of claim 1, wherein the core is fixed thereon with a suction magnet to face a surface of the rotor yoke for inhibiting the rotor from floating.
